(19) United States
(12) Patent Application Publication
(10) Pub. No.: US 2010/0051712 A1
(43) Pub. Date: Mar. 4, 2010

(54) Variable Air Intake Opening for a Vehicle

(75) Inventor: Daniel B. Lebeck, Farmington Hills, MI (US)

Correspondence Address: YOUNG BASILE, 3001 WEST BIG BEAVER ROAD, SUITE 624, TROY, MI, 48084, US

(73) Assignee: NISSAN TECHNICAL CENTER NORTH AMERICA, INC., Farmington Hills, MI (US)

(21) Appl. No.: 12/202,046

(22) Filed: Aug. 29, 2008

(51) Int. Cl. B60H 1/02

(52) U.S. Cl. 237/12.3 A

(57) ABSTRACT

An air intake for a climate control system of a vehicle. The air intake includes an inlet having a cover with holes to permit a flow of air into a chamber when the vehicle is moving. The chamber is adjacent to the inlet and has an outlet that channels the flow of air from the cover through the chamber and to the climate control system. The chamber is positioned in the vehicle to absorb heat from the engine. An adjustable baffle regulates the flow of air through the cover into the chamber. A thermally-responsive actuator is exposed to the ambient air. The actuator is configured to move the baffle to reduce the flow of air into the chamber in response to lower ambient air temperature and increase the flow in response to higher ambient air temperature. The cover can be a cowl and the chamber a cowl box.

### FIELD OF THE INVENTION

The present invention relates to the field of ventilation for the passenger compartment of vehicles and in particular to ventilation systems that have adjustable air intake.

### BACKGROUND

The cowl of a motor vehicle, located between the hood and the windshield, performs several functions. The cowl functionally and aesthetically spans the gap between the windshield and hood and accepts components of the windshield wiper and washer system. Motor vehicles, i.e., passenger cars, pickup trucks, SUVs, recreational vehicles and semi trucks, also draw air for heating, cooling and ventilating the passenger compartment of the motor vehicle through the cowl. The air is heated or cooled in the vehicle's HVAC system.

Internal combustion engines in these motor vehicles produce heat during operation. Although this heat is dissipated within the engine compartment with the use of heat exchangers, radiators, forced convection, fans and the like, the components within the compartment are heated as the engine runs. One of these components is the cowl box. The efficiency of the HVAC system could be improved and the functionality of the cowl increased if the heat could be both effectively recovered or effectively removed.

### SUMMARY

Disclosed herein are variable air intakes for climate control of the passenger compartment of a vehicle having an engine. One embodiment of an air intake for a climate control system of a vehicle disclosed herein comprises a chamber configured to absorb waste heat generated by the engine. The chamber has an inlet configured to receive an air flow from outside of the vehicle and an outlet configured to channel at least a portion of the air flow to the climate control system. A cover is positioned over the inlet and has at least one aperture therein to permit a flow of air therethrough. An adjustable baffle is movably disposed relative to the cover to regulate a flow rate of air through the at least one aperture, and a thermally-responsive actuator is configured to move the adjustable baffle to increase and decrease a residence time of the air flow in the chamber in transit from the inlet to the outlet in response to changes in ambient air temperature.

Another embodiment of a variable air intake for a climate control system of a vehicle having an engine disclosed herein comprises a cowl having at least one aperture to permit a flow of air therethrough. A cowl box adjacent to the cowl has an outlet configured to channel at least a portion of the flow of air from the cowl through the cowl box and to the climate control system, wherein the cowl box is positioned in the vehicle to absorb heat from the engine. An adjustable baffle is movably disposed adjacent the cowl and within the cowl box to regulate the flow of air through the cowl into the cowl box. A thermally-responsive actuator is configured to move the adjustable baffle to reduce the flow of air into the cowl box in response to lower ambient air temperature and to increase the flow of air into the cowl box in response to higher ambient air temperature.

### BRIEF DESCRIPTION OF THE DRAWINGS

The description herein makes reference to the accompanying drawings wherein like reference numerals refer to like parts throughout the several views, and wherein:

FIG. 1 is a perspective view of an air intake arrangement;

FIG. 2 is a top plan view of the air intake arrangement shown in FIG. 1;

FIG. 3 is a sectional view of the air intake arrangement shown in FIG. 2;

FIG. 4 is a schematic diagram showing the flow of air through the air intake arrangement of FIG. 3;

FIG. 5 is an exploded perspective view of an embodiment of a cover and adjustable baffle of a variable air intake system shown in FIG. 3;

FIG. 6 is an exploded perspective view of another embodiment of a cover and adjustable baffle of a variable air intake system shown in FIG. 3;

FIG. 7 is a top plan view of the cover and adjustable baffle of FIG. 6, showing the baffle positioned to permit maximum airflow through the inlet cover;

FIG. 8 is a top plan view of the cover and adjustable baffle of FIG. 6, showing the baffle moved to block a portion of airflow through the inlet cover, and also showing an actuator used to move the baffle;

FIG. 9 is a top plan view of a cover and adjustable baffle in accordance with an other embodiment; and

FIG. 10 is an adjustable baffle in accordance with yet another embodiment.

### DETAILED DESCRIPTION

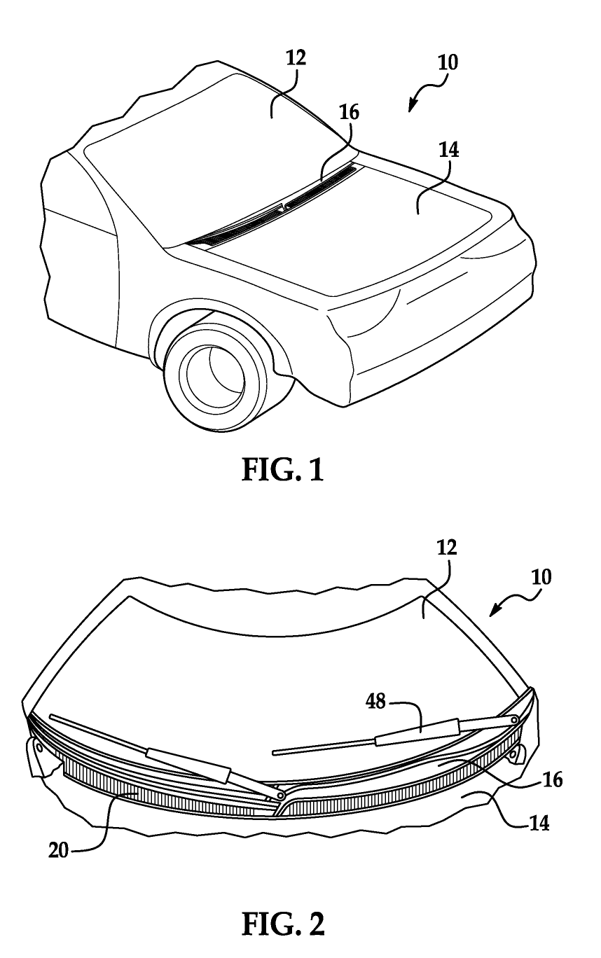

FIG. 1 is a perspective view of a vehicle incorporating an embodiment of a variable air intake. FIG. 2 is a top plan view of an air intake arrangement. Referring to FIGS. 1 and 2, a vehicle 10 (in this case, a passenger car) is shown having a windshield 12, a hood 14, and a covert 16, positioned between the windshield 12 and hood 14. The cover 16 is shown having apertures 20 for air intake.

The cover 16 can be made from metal or plastic. Typically, the cover is a rigid thermoplastic material. The term “rigid” as used herein means reasonably inflexible, reasonably resistant to impact and capable of supporting itself over the region it extends. The cover 16 may be fabricated as one piece or more than one piece. The cover 16 can be a planar surface or a curved surface. The apertures 20 in the cover 16 are not limited to the shape and configuration shown in FIGS. 1 and 2. The apertures may be any shape and configuration required or desired to provide the necessary air flow to the HVAC unit. The apertures may be shaped and configured to be aesthetically pleasing as well as functional.

The vehicle 10 shown in FIGS. 1 and 2 is provided by way of example and not limitation. The embodiments of the variable air intake can be implemented in different kinds of vehicles, for example, pickup trucks, SUVs, semi trucks, and recreational vehicles.

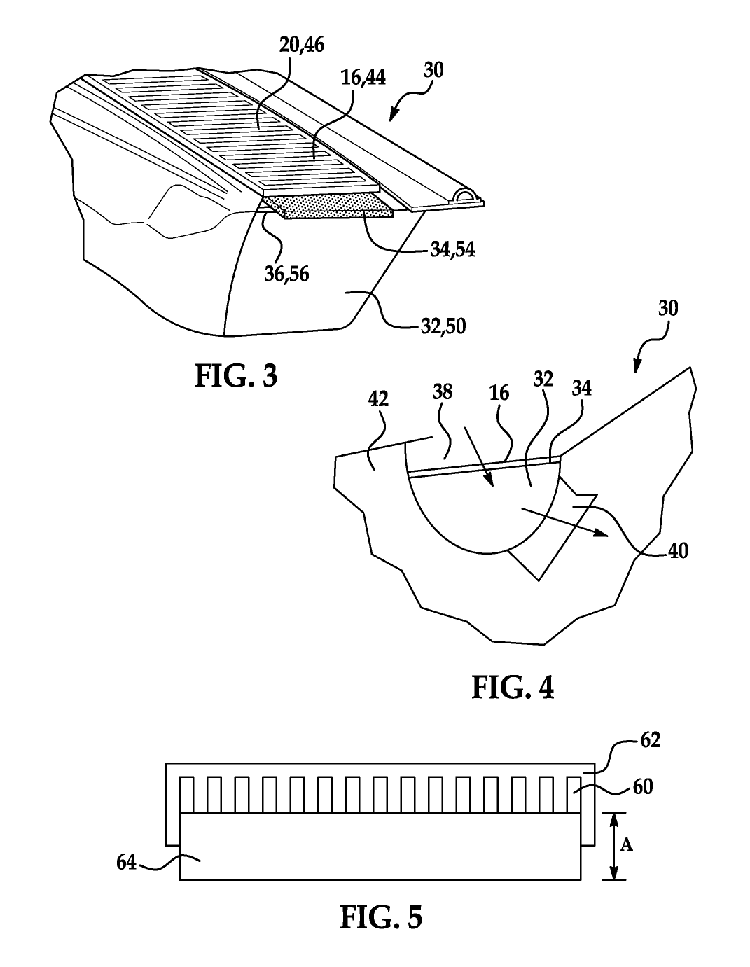

FIG. 3 is a cross-sectional view of FIG. 2, showing an embodiment of the variable air intake system disclosed herein. The variable air intake system 30 comprises a chamber 32, a cover 16 having at least one aperture 20, an adjustable baffle 34, and a thermally-responsive actuator 36. The chamber 32 has an inlet 38 fitted with the cover 16 and an outlet 40, seen schematically in FIG. 4.

FIG. 4 is a schematic diagram showing the flow of air through the variable air intake system 30 of FIG. 3. The inlet 38 of the chamber 32 is configured to receive an air flow from outside of the vehicle and into the chamber 32. The chamber 32 channels at least a portion of that air flow through the outlet 40 and into the climate control system (not shown). The cover 16 is positioned over the inlet 38 with the at least one aperture 20 (shown in FIG. 3) permitting the flow of air through the inlet 38. The adjustable baffle 34 is movably disposed relative to the cover 16 to regulate the flow rate of air through the at least one aperture 20. The adjustable baffle 34 is controlled with the thermally-responsive actuator 36 (shown in FIG. 3), which is configured to move the adjustable baffle 34 to increase and decrease a residence time of the air flow in the chamber 32 in transit from the inlet 38 to the outlet 40 in response to changes in ambient air temperature.

The chamber can be a recess between other components or can be a separate container. The air flow from the chamber to the climate control system can be direct through the outlet or can be indirect, with one or more components in between.

When the engine of the vehicle is running, the engine generates heat. Although there are means within an engine compartment 42 to cool the engine, such as fans and radiator units, the components within the engine compartment 42 of the vehicle absorb some of the heat generated. This energy from this heat has typically been wasted. The chamber 32 of the variable air intake system 30 is one such component that absorbs the heat generated by the engine. This heat absorbed by the chamber 32 can be controlled to improve the efficiency of the climate control system and improve the comfort of the passengers in the vehicle 10 (shown in FIG. 1).

To utilize this heat, the air entering the inlet 38 of the chamber 32 can be slowed down in the chamber 32 such that the air absorbs the heat from the chamber 32 before exiting the outlet 40 into the climate control system. To increase the residence time of the air in the chamber 32, thereby heating the air, the adjustable baffle 34 can be moved by the thermally-responsive actuator 36 to partially cover the at least one aperture 20 of the cover 16 to reduce the air flow into the chamber 32. When the at least one aperture 20 of the cover 16 is restricted, there is less air entering the chamber 32, the pressure differential and the mass flow rate through the chamber 32 is reduced so that the time the air spends in the chamber 32 is increased and the air has more time to absorb the chamber's heat. This heated air then enters the climate control system through the outlet 40 of the chamber 32 at an increased temperature, thereby increasing the effectiveness of the climate control system. The passengers in the vehicle can receive heat more quickly, and the passenger compartment may be heated to higher temperatures then without the variable air intake system.

It may be desired to offset the effect of the heat absorbed by the chamber 32 to more efficiently and effectively cool the passenger compartment of the vehicle. To achieve this, the velocity of the air entering the inlet 38 of the chamber 32 can be increased through the chamber 32 such that the air absorbs less heat from the chamber 32 before exiting the outlet 40 into the climate control system. To decrease the residence time of the air in the chamber 32, thereby maintaining more closely the ambient temperature of the air, the adjustable baffle 34 can be moved by the thermally-responsive actuator 36 to increase the opening of the at least one aperture 20 of the cover 16 to increase the air flow into the chamber 32.

When the open area of the at least one aperture 20 of the cover 16 is increased, more air enters the chamber 32, and the pressure differential and the mass flow rate through the chamber 32 are increased so that the time the air spends less time in the chamber 32. The air has less time to absorb the chamber's heat, resulting in cooler air. This cooler air then enters the climate control system through the outlet 40 of the chamber 32 at a temperature at or near ambient, thereby increasing the effectiveness of the climate control system when the passengers are calling for cooling. The passengers in the vehicle can receive cold air more quickly and the passenger compartment may cool to lower temperatures than achievable without the variable air intake.

The cover 16 of the variable air intake system 30 of FIG. 3 for a climate control system of a vehicle 10 having an engine can be a cowl 44 having at least one aperture 46 to permit a flow of air therethrough. The cowl 44 can support a set of windshield wipers 48, as shown in FIG. 2. The chamber 32 can be a cowl box 50 adjacent to the cowl 44 and configured with an outlet (shown as 40 in FIG. 4) to channel at least a portion of the flow of air from the cowl 44 through the cowl box 50 and to the climate control system (not shown). The positioning of the cowl box 50 is within the engine compartment 42 such that the cowl box 50 absorbs heat from the engine. An adjustable baffle 54 is movably disposed adjacent the cowl 44 and within the cowl box 50 to regulate the flow of air through the cowl 44 into the cowl box 50. The adjustable baffle 54 can be located outside of the cowl box 50 if desired or required. A thermally-responsive actuator 56 is configured to move the adjustable baffle 54 to reduce the flow of air into the cowl box 50 in response to lower ambient air temperature and to increase the flow of air into the cowl box 50 in response to higher ambient air temperature.

The thermally-responsive actuator 36, 56 can be a bimetallic spring as shown in FIG. 8. The bimetallic spring could be located in the chamber 32, 50 in a position in which it was in contact with ambient air. The bi-metallic spring could be located outside the chamber 32, 50 as desired or required. Typically, the bimetallic spring can unwind as the ambient air temperature increases, moving the adjustable baffle 34, 54 to increase the opening of the at least one aperture 20, 46. However, the bimetallic spring can be configured as desired or required such that one of winding or unwinding opens the area of the at least one aperture 20, 46 and the other reduces the area of the opening.

The thermally-responsive actuator 36, 56 can be an electronic actuator including a temperature sensor. The temperature sensor can be located anywhere on the vehicle so long as it is in contact with ambient air. The electronic actuator can move the adjustable baffle 34, 54 in response to the ambient air temperature read by the sensor. The electronic actuator and the bimetallic spring are provided by means of example and are not meant to be limiting. For example, the actuator could be responsive to additional parameters besides temperature, such as manual input. It could be made of plastic or metal. It could be actuated by a hydraulic system or by fluid that contracts and expands with heat, or it could be a step motor. Any actuator known to those skilled in the art can be used.

The actuator 36, 56 can be configured to move the adjustable baffle 34, 54 to reduce the flow rate of air through the at least one aperture 20, 46 when the ambient air temperature falls below a first threshold amount, and to increase the flow rate of air through the at least one aperture 20, 46 when the ambient air temperature rises above a second threshold amount. The thresholds can be set by the manufacturer or can be set by the user.

The actuator 36, 56 can be further configured to continue to move the adjustable baffle 34, 54 to reduce the flow rate of air gradually through the at least one aperture 20, 46 as the ambient air temperature continues to fall, and to increase the flow rate of air through the at least one aperture 20, 46 gradually as the ambient air temperature continues to rise.

The actuator 36, 56 can be configured to move the adjustable baffle 34, 54 to reduce the flow rate of air through the at least one aperture 20, 46 when the ambient air temperature falls below each of a plurality of descending temperature stages, and to increase the flow rate of air through the at least one aperture 20, 46 when the ambient air temperature rises above each of a plurality of increasing temperature stages.

The adjustable baffle 34, 54 can be configured to respond to a user's input in addition to the ambient air temperature. The actuator 36, 56 can be overridden by the user's input if desired or required, or the user's input may be in addition to the actuator's response to the ambient air temperature. These operational variations of the actuator 36, 56 are provided by way of example and not limitation and other responses known to those skilled in the art are contemplated.

One embodiment of a cover and an adjustable baffle is shown in FIG. 5. The at least one aperture 60 in the cover 62 can be a plurality of apertures with elongate openings. The cover 62 can be planar as shown in the figures, or can be curved, depending on the inlet it must cover. The adjustable baffle 64 can also be planar or curved, and will likely follow the same shape as the cover 62. The adjustable baffle 64 shown in FIG. 5 is a solid piece, meaning it has no apertures. The adjustable baffle 64 is moved relative to the cover 62 to increase the area of the plurality of apertures 60 or decrease the area of the plurality of apertures 60 as described above. The adjustable baffle 64 can be moved in the direction of arrow A or in a direction perpendicular to arrow A.

It is contemplated that the adjustable baffle 64 movement is stopped before the plurality of apertures 60 is completely restricted, thereby providing a minimum of flow to the climate control system. It is further contemplated that the adjustable baffle 64 may have a smaller surface area than the cover 62, thereby constantly leaving at least one aperture 60 unrestricted. The adjustable baffle 64 may further be more than one piece, such that at least one aperture in the middle of the cover constantly be unrestricted, for example. It is contemplated that the at least one aperture 60 close to the intake of the climate control system will be the area in which the at least one unrestricted aperture will be located. There can be a limit to the amount of area opened; however, it is contemplated that all of the apertures 60 can be fully opened if desired or required. The adjustable baffle can be made of metal, plastic or other suitable material. It can be positioned directly adjacent the cover or spaced apart from the cover.

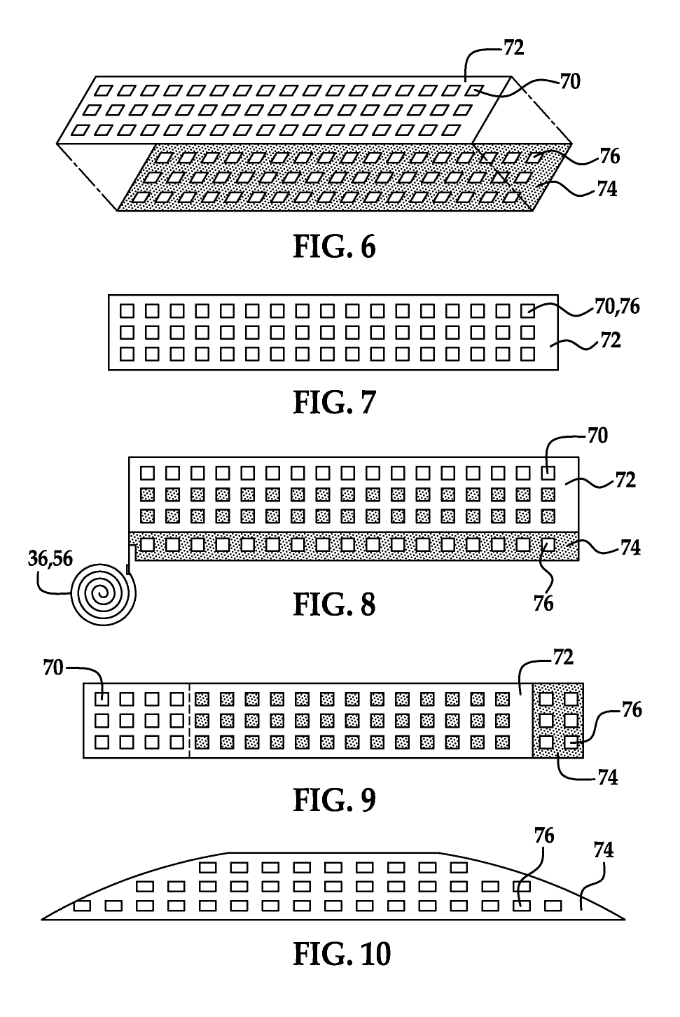

Another embodiment of a cover and an adjustable baffle is shown in FIG. 6. The at least one aperture 70 in the cover 72 can be a plurality of apertures 70 positioned in a grid-like fashion across the cover 72. The apertures 70 can be located along perpendicular lines and/or parallel lines, or be offset. The apertures 70 can be in a pattern. The examples shown in the figures are meant to be non-limiting and other aperture configurations are contemplated. The adjustable baffle 74 in FIG. 6 is shown having the same pattern of apertures 76 as the corresponding cover 72. This is shown by way of example and not limitation. It is contemplated that a solid baffle be used with any cover aperture pattern produced.

The adjustable baffle 74 can be moved relative to the cover 72 to increase the area of the plurality of apertures 70 or decrease the area of the plurality of apertures 70 as described above. The movement of the adjustable baffle 74 changes at least partial alignment of the baffle's apertures 76 with the corresponding apertures 70 of the cover 72. When the apertures 70, 76 of the cover 72 and baffle 74 are aligned, the open area of the aperture 70 is at its greatest, allowing the greatest amount of air to pass through, as shown in FIG. 7. When the apertures 76 of the adjustable baffle 74 are moved offset from the apertures 70 of the cover 72, the opened area of the apertures 70 is reduced, decreasing the flow of air, as shown in FIG. 8.

It is contemplated that the adjustable baffle 74 movement is stopped before the plurality of apertures 70 is completely restricted, thereby providing a minimum of flow to the climate control system. The movement of the adjustable baffle 74 relative to the cover 72 can be forward and back, as represented by FIG. 8, or side to side, as shown in FIG. 9. It is further contemplated that the adjustable baffle 74 may have a smaller surface area than the cover 72, thereby constantly leaving at least one aperture 70 unrestricted, as shown in FIG. 10. The adjustable baffle 74 may further be more than one piece, such that at least one aperture in the middle of the cover constantly be unrestricted, for example. It is contemplated that the at least one aperture close to the intake of the climate control system will be the area in which the at least one unrestricted aperture will be located. There can be a limit to the amount of area opened; however, it is contemplated that all of the apertures can be fully opened if desired or required.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An air intake for a climate control system of a vehicle having an engine, comprising:
a chamber configured to absorb waste heat generated by the engine, the chamber having an inlet configured to receive an air flow from outside of the vehicle and an outlet configured to channel at least a portion of the air flow to the climate control system;
a cover positioned over the inlet and having at least one aperture therein to permit a flow of air therethrough;
an adjustable baffle movably disposed relative to the cover to regulate a flow rate of air through the at least one aperture;
a thermally-responsive actuator configured to move the adjustable baffle to increase and decrease a residence time of the air flow in the chamber in transit from the inlet to the outlet in response to changes in ambient air temperature.

2. The air intake of claim 1, wherein the chamber is a cowl box and the cover is a cowl.

3. The air intake of claim 1, wherein the actuator is a bimetallic spring.

4. The air intake of claim 1, wherein the actuator is an electronic actuator including a temperature sensor.

5. The air intake of claim 1, wherein the adjustable baffle further comprises at least one aperture that moves into and out of at least partial alignment with the at least one aperture of the cover when the actuator moves the adjustable baffle.

6. The air intake of claim 1, wherein the cover has a plurality of spaced-apart apertures over a generally planar surface.

7. The air intake of claim 4, wherein the adjustable baffle is a planar member having a plurality of apertures that move into and out of at least partial alignment with the plurality of apertures on the cover when the actuator moves the adjustable baffle.

8. The air intake of claim 1, wherein the actuator is configured to move the adjustable baffle to reduce the flow rate of air through the at least one aperture when the ambient air temperature falls below a first threshold amount, and to increase the flow rate of air through the at least one aperture when the ambient air temperature rises above a second threshold amount.

9. The air intake of claim 8, wherein the actuator is further configured to continue to move the adjustable baffle to reduce the flow rate of air through the at least one aperture as the ambient air temperature continues to fall, and to increase the flow rate of air through the at least one aperture as the ambient air temperature continues to rise.

10. The air intake of claim 1, wherein the actuator is configured to move the adjustable baffle to reduce the flow rate of air through the at least one aperture when the ambient air temperature falls below each of a plurality of descending temperature stages, and to increase the flow rate of air through the at least one aperture when the ambient air temperature rises above each of a plurality of increasing temperature stages.

11. The air intake of claim 1, wherein the adjustable baffle is positioned to regulate the air flow through the apertures located nearest the outlet.

12. The air intake of claim 6, wherein at least one of the plurality of spaced-apart apertures remains unobstructed by the adjustable baffle.

13. The air intake of claim 1, wherein the adjustable baffle is configured to respond to a user input in addition to changes in ambient air temperature.

14. An air intake for a climate control system of a vehicle having an engine, comprising:
a cowl having at least one aperture to permit a flow of air therethrough;
a cowl box adjacent to the cowl and having an outlet configured to channel at least a portion of the flow of air from the cowl through the cowl box and to the climate control system, wherein the cowl box is positioned in the vehicle to absorb heat from the engine;
an adjustable baffle movably disposed adjacent the cowl and within the cowl box to regulate the flow of air through the cowl into the cowl box;
a thermally-responsive actuator configured to move the adjustable baffle to reduce the flow of air into the cowl box in response to lower ambient air temperature and to increase the flow of air into the cowl box in response to higher ambient air temperature.

15. The air intake of claim 14, wherein the actuator is a bimetallic spring.

16. The air intake of claim 14, wherein the actuator is an electronic actuator including a temperature sensor.

17. The air intake of claim 14, wherein the adjustable baffle further comprises at least one aperture that moves into and out of at least partial alignment with the at least one aperture of the cowl when the actuator moves the adjustable baffle.

18. The air intake of claim 14, wherein the cowl has a plurality of spaced-apart apertures over a generally planar surface.

19. The air intake of claim 17, wherein the adjustable baffle is a planar member having a plurality of apertures that move into and out of at least partial alignment with the plurality of apertures on the cowl when the actuator moves the adjustable baffle.

20. The air intake of claim 18, wherein at least one of the plurality of spaced-apart apertures remains unobstructed by the adjustable baffle.

21. The air intake of claim 14, wherein the actuator is configured to move the adjustable baffle to reduce the flow rate of air through the at least one aperture when the ambient air temperature falls below a first threshold amount, and to increase the flow rate of air through the at least one aperture when the ambient air temperature rises above a second threshold amount.

22. The air intake of claim 21, wherein the actuator is further configured to continue to move the adjustable baffle to reduce the flow rate of air through the at least one aperture as the ambient air temperature continues to fall, and to increase the flow rate of air through the at least one aperture as the ambient air temperature continues to rise.

23. The air intake of claim 14, wherein the actuator is configured to move the adjustable baffle to reduce the flow rate of air through the at least one aperture when the ambient air temperature falls below each of a plurality of descending temperature stages, and to increase the flow rate of air through the at least one aperture when the ambient air temperature rises above each of a plurality of increasing temperature stages.

24. The air intake of claim 14, wherein the adjustable baffle is positioned to regulate the air flow through the apertures located nearest the outlet.

25. The air intake of claim 14, wherein the adjustable baffle is configured to respond to a user input in addition to changes in ambient air temperature.
